(19) United States
(12) Patent Application Publication
(10) Pub. No.: US 2017/0328737 A1
(43) Pub. Date: Nov. 16, 2017

(54) TRANSDUCER ASSEMBLY FOR A TORQUE AND/OR ANGLE SENSOR

(71) Applicants: ThyssenKrupp Presta AG, Eschen (LI); thyssenkrup AG, Essen (DE)

(72) Inventors: Sedat Sen, Sennwald (CH); Peter Knoll, Lindau (DE); Julian Sandholzer, Altach (AT); Gernot Ernstson, Feldkirch (AT); Sebastian Vinzenz, Ludesch (AT)

(73) Assignees: ThyssenKrupp Presta AG, Eschen (LI); thyssenkrupp AG, Essen (DE)

(21) Appl. No.: 15/536,293

(22) PCT Filed: Sep. 22, 2015
(86) PCT No.: PCT/EP2015/071738

§ 371 Date: Jun. 15, 2017

(30) Foreign Application Priority Data
Dec. 19, 2014 (DE) 10 2014 018 783.7

(51) Int. Cl. G01D 5/14; G01L 3/10

(52) U.S. Cl. CPC G01D 5/14; G01L 3/101

(57) ABSTRACT

A transducer assembly for a torque and/or angle sensor may comprise a pipe section-shaped magnet ring that is secured to a carrier sleeve via an intermediate element. The intermediate element and the magnet ring may be integrally bonded to one another via joining surfaces directed against one another. The intermediate element may be formed of a plastic at least in a region of its joining surface. To provide a transducer assembly that can be more easily produced and assembled with high reliability, the magnet ring may be formed as a plastic-bonded magnet from a plastic material filled with magnetic particles, which is integrally bonded to the plastic of the intermediate element.”

### PRIOR ART

The invention concerns a transducer assembly for a torque and/or angle sensor, comprising a pipe section-shaped magnet ring, which is secured to a carrier sleeve via an intermediate element, wherein the intermediate element and the magnet ring are integrally bonded to one another via joining surfaces directed against one another, and the intermediate element is formed of a plastic at least in the region of the joining surface.

In power-assisted steering systems of motor vehicles, the steering torque introduced by the driver through the steering wheel into the steering shaft is detected and an assisting torque derived from this is coupled into the steering system. The determination of the torque is done by measuring the relative angle of rotation between two segments of the steering shaft, coupled by a torsion bar, i.e., the torque-dependent twisting. The relative angle of rotation can be detected by means of a magnetic sensor of the angle of rotation, in which a transducer element of the kind mentioned at the outset is arranged on the one segment of the steering shaft, rotationally fixed to a coaxial magnet ring, and on the other segment of the steering shaft a magnetic field sensing arrangement, which detects changes in the magnetic field during a relative twisting of said magnet ring and relays them as a control variable to the power assistance system. Furthermore, the overall magnitude of the steering angle can be determined by an evaluation of the changes in the magnetic field of the magnet ring relative to the stationary vehicle body.

In the prior art, there is known from DE 10 2008 047 466 A1 a transducer assembly in the form of a magnet assembly. The securing to a steering shaft is done by means of a pipe section-shaped carrier sleeve, which is arranged in a rotationally fixed manner and coaxially to the likewise pipe section-shaped magnet ring. In order to prevent, for example during temperature changes of the carrier sleeve which is usually made of metal, mechanical stresses from being exerted on the magnet ring, an intermediate element is arranged between the carrier sleeve and the magnet ring, so that the magnet ring is only coupled mechanically to the intermediate element and is decoupled from the carrier sleeve. It is proposed to cast the magnet ring with the intermediate element made of plastic in the injection molding process, so that the magnet ring is connected in a form-fitting and/or integrally bonded manner with the plastic of the intermediate element by means of intermeshing or undercutting geometries.

While the connection in the injection molding process by inserting the magnet ring into the injection casting mold is reliable, it is complicated and inflexible in terms of manufacturing technology. This procedure of the prior art is explained by the fact that the ferromagnetic sinter material usually employed for the magnet ring is relatively brittle and accordingly sensitive to mechanical stresses. The form-fitting elements additionally provided in the joining surface on the magnet ring—the aforementioned intermeshing or undercutting geometries—are required on account of the material properties of the sinter material in regard to the connection with the plastic intermediate element and involve a significant manufacturing expense for the magnet ring.

It is known from EP 1 123 794 B1 to design the magnet ring as a plastic-bonded magnet, in the form of a plastic part highly filled with magnetic powder. The greater mechanical loading capacity of the magnet accomplished in this way should be utilized for a force-mediated and/or form-fitting connection to an intermediate element, which is connected in a known fashion to the carrier sleeve. As in the aforementioned DE 10 2008 047 466 A1, form-fitting elements must likewise be realized, resulting in a correspondingly higher manufacturing and assembly expense.

The drawback to the magnetic transducer assemblies known in the prior art is the costly manufacturing and assembly procedures needed for their realization.

In view of the above-discussed problems, the problem of the present invention is to indicate a transducer assembly which is easier to manufacture and assemble, along with high reliability.

### PRESENTATION OF THE INVENTION

For the solving of the aforementioned problems, it is proposed according to the invention that the magnet ring is formed as a plastic-bonded magnet from a plastic material filled with magnetic particles, which is integrally bonded to the plastic of the intermediate element.

The magnet ring of a transducer element according to the invention consists of a composite material, in which ferromagnetic magnetic powder—preferably hard ferrite or rare earth magnetic powder—is embedded in a plastic matrix. The magnetic properties are determined by the magnetizable material and the degree of filling, which gives the weight fraction of the magnetic powder in relation to the plastic material of the plastic matrix. Because the magnetic particles are adhesively and cohesively bound in the plastic matrix, advantageous properties of the magnet ring result, namely, a greater mechanical and thermal stability and fracture strength. This circumstance is utilized for the form-fitting and force-mediated fixation of the magnet ring, as described in the prior art.

For the first time the present invention enables a substantial simplification of the formerly costly placement of the magnet ring on the intermediate element by producing, instead of a form-fitting or force-mediated connection, a durable integrally bonded connection between the joining surfaces of magnet ring and intermediate element which are directed against one another, i.e., lying against one another. In contrast with the prior art, in which costly combined joining techniques are required in order to observe the dictated safety standards for the fastening of the magnet ring on the carrier sleeve, according to the invention an especially secure, permanently strong and reliable connection by integral bonding is made possible.

The special benefit of the invention is based on the fact that strong integrally bonded connections can only be realized in sufficient durable manner if both joining partners—here, the magnet ring and the intermediate element—comprise materials at least in the region of their joining surfaces which are compatible, i.e., as best suited as possible, for an integrally bonded connection. In the invention, this can be realized in that the plastic matrix of the magnet ring and the plastic from which the intermediate element is made are selected from plastic materials which are compatible with each other in terms of the parameters which define the strength of an integrally bonded connection, such as material-specific adhesion behavior, surface texture, etc. Specifically, in order to realize the invention, the plastic matrix in which the magnetic material is embedded is appropriately matched up with the plastic from which the intermediate element is made.

In terms of a rational production of a transducer assembly according to the invention, it is advantageous that the magnet ring and the intermediate element can be prepared individually and only joined integrally to each other during the assembly of the carrier sleeve. This enables less manufacturing cost and greater flexibility than with the transducer assemblies known in the prior art.

An especially preferred embodiment of the invention calls for the plastic of the intermediate element and the plastic material of the magnet ring to be thermoplastic polymers which are compatible in terms of an integrally bonded connection. Thermoplastic polymers can be adapted to the most diverse of requirements in regard to their mechanical, thermal and chemical material properties and can be easily processed by means of thermal production processes, such as plastic injection molding. In this way, both the intermediate element and the magnet ring can be made economically as injection molded parts with low cost. For the plastic matrix of the magnet ring, it will be considered that a sufficiently high degree of filling with magnetic particles and a processing by means of established thermal plastics processing methods such as injection molding, hot forming, and the like is possible. The plastic material of the intermediate element preferably comprises a similar or identical polymer matrix to the magnet ring. In this way, an especially secure integrally bonded connection can be produced by means of thermal joining techniques, with a homogeneous material structure over the entire joining site, i.e., the plastic in the joining site has identical material properties as that inside the joining partner. An integrally bonded connection by means of gluing that is especially secure and durable can also be realized when the adhesive used can be optimally adapted to the single plastic material used for both the magnet ring and intermediate element, or the compatible and thus similar plastic materials. This likewise ensures a firm and secure adherence to the joining surfaces of the magnet ring and intermediate element.

As the thermoplastic polymers it is possible to use, for example, polyamides (PA), polypropylenes (PP), polyphenylene sulfides (PPS) or other thermoplastic plastics.

Advantageously, the intermediate element and/or the magnet ring is/are formed as an injection molded part. The manufacturing in plastic injection molding can be done rationally with the required properties. Alternatively, the magnet ring can be formed as a pressed part, by which a higher degree of filling with magnetic particles can be achieved.

Preferably, the plastic material from which the magnet ring is made is highly filled with magnetic particles, preferably with a degree of filling between 80% and 97% in terms of weight. For a manufacturing by injection molding the range of 84% to 94% is especially suitable, for a pressed part the range up to 97%.

In one advantageous development of the invention, the intermediate element and the magnet ring are welded, preferably ultrasound welded. During the welding, the plastic material is locally melted by heat in the region of both joining surfaces and brought into contact with each other, so that upon solidification of the melt a homogeneous material texture is produced throughout. For the integrally bonded connection of plastic parts, friction welding methods are especially well suited, being termed here in general as ultrasound welding. In this process, oscillations are coupled into the joining site by a welding punch, in the case of ultrasound welding a so-called sonotrode, and the joining surfaces are locally melted and joined to each other by a resulting internal molecular and boundary surface friction. After the solidification, the magnet ring and the intermediate element together form a single structural element, which can no longer be separated nondestructively by the integrally bonded or intimate material connection of the plastics involved. Alternatively to ultrasound welding, a welding by means of laser beam can also be employed.

Furthermore, to improve the ultrasound welding, it is advantageous to form reservoirs of welding material projecting on the intermediate element and/or on the magnet ring relative to the joining surface. These are also known as welding preparations and can be formed by ribs or protrusions formed on the respective joining surface of the joining partner or partners. When the joining surfaces are brought together, the welding preparations first come into contact, melt, and fill the joint gap in an integrally bonded manner. This ensures the quality of the welding within relatively large dimensional tolerances.

An alternative form of the integrally bonded connection calls for the intermediate element and the magnet ring to be glued together. The gluing is done with an adhesive which adheres in optimal fashion to the plastic material of both the magnet ring and the intermediate element. In the invention, this can be accomplished by using compatible plastics comprising identical or at least very similar adhesion properties in regard to an integrally bonded connection by means of the adhesive. In a manner known per se, the adhesive can be applied to one or both joining surfaces, which are then brought into contact. The assembly of the magnet ring and the intermediate element together with the carrier sleeve can be done efficiently in this way.

Preferably the magnet ring is connected on a substantially axial end face to an axial end face of the intermediate element. It is possible to form a circular ring or circular ring segment-shaped joining surface on an end face of the substantially pipe section-shaped magnet ring, corresponding to a corresponding joining surface on the intermediate element.

For the relative orientation or fixation, form-fitting elements may be arranged in the region of the joining surfaces on the magnet ring and/or the intermediate element. The form-fitting elements may comprise protrusions and depressions corresponding to each other, for example, which mesh together when the joining surfaces are put together. Alternatively, it is conceivable to use positioning pins through corresponding apertures or recesses in the magnet ring and in the intermediate element in form-fitting fashion. In this way, an optimal relative positioning can be ensured during the mounting of the magnet ring on the intermediate element. After the integrally bonded connection is assembled, the positioning pins can be removed once more, or left behind in the structural part.

The carrier sleeve can be fashioned as a pipe section and comprise an outwardly protruding fastening element in one end region. The fastening element can be flangelike, with an outer fully encircling collar or flange ring, or a plurality of protrusions or flange segments protruding radially from the pipe section. The flange ring or the flange segments can be connected to the intermediate element, for example by an integrally bonded and/or form-fitting connection. The fastening element can be arranged at the end face or at a spacing from the end.

For the axial fixation, the fastening element can be arranged axially in a form-fitting manner between end faces of the magnet ring and intermediate element which are directed against one another. As already described above, the connection of magnet ring and intermediate element according to the invention forms a single structural part. If an axially open recess is provided in the region of the joining plane in the magnet ring and/or in the intermediate element, receiving a fastening element of the carrier sleeve, this will be held axially in a form-fitting manner between the end faces of the magnet ring and intermediate element after the joining according to the invention. A play may be present in the radial direction, so that a thermal expansion of the carrier sleeve, typically made of metal, preferably of steel, does not transmit any stresses to the magnet ring.

Alternatively, the intermediate element can be arranged axially between end faces of the magnet ring and fastening element which are directed against one another. For this, the intermediate element can be designed as a continuous ring or comprise a plurality of intermediate elements arranged as segments, while on the axial end face of the ring or the intermediate elements the end face of the magnet ring is fastened in an integrally bonded manner according to the invention, and on the opposite axial end face the fastening element or elements of the carrier sleeve is/are fastened. Preferably, the fastening element can comprise at least one axial aperture, fitted at least partially with an intermediate element. In this way, a form-fitting connection can be realized, ensuring a secure connection between the intermediate element consisting of plastic and the metallic carrier sleeve.

A method of producing of a transducer assembly according to the invention involves the following steps:
providing of a plastic-bonded magnet ring,
integrally bonded connecting of the magnet ring to an intermediate element made of plastic,
fastening of the intermediate element to a carrier sleeve.

The integrally bonded connecting of the magnet ring to the intermediate element as described above can be done before the carrier sleeve is placed on the intermediate element—or—the carrier sleeve is enclosed or gripped in a form-fitting manner during the integrally bonded connection between the magnet ring and the intermediate element.

In each of the aforementioned cases, the integrally bonded connection according to the invention ensures a relatively low manufacturing cost and a simple and thus secure mounting of the carrier sleeve.

### DESCRIPTION OF THE DRAWINGS

Advantageous embodiments of the invention shall be explained more closely below with the aid of the drawings. Specifically, there are shown:

FIG. 1: a transducer assembly according to the invention in perspective view,

FIG. 2: a longitudinal section through the transducer assembly per FIG. 1,

FIG. 3: an exploded view of the transducer assembly per FIG. 1,

FIG. 4: a longitudinal section as in FIG. 2 through the elements of the transducer assembly before mounting,

FIG. 5: a detail view of the cross-sectional representation of FIG. 2,

FIG. 6: a partial longitudinal section through a second embodiment of a transducer assembly according to the invention,

FIG. 7: a partial longitudinal section through a third embodiment of a transducer assembly according to the invention,

FIG. 8: a partial longitudinal section through a fourth embodiment of a transducer assembly according to the invention,

FIG. 9: a partial longitudinal section through a fifth embodiment of a transducer assembly according to the invention,

FIG. 10: a partial longitudinal section through a sixth embodiment of a transducer assembly according to the invention.

### EMBODIMENTS OF THE INVENTION

In the different figures, the same parts are always provided with the same reference numbers and therefore as a rule they will only be designated or mentioned once.

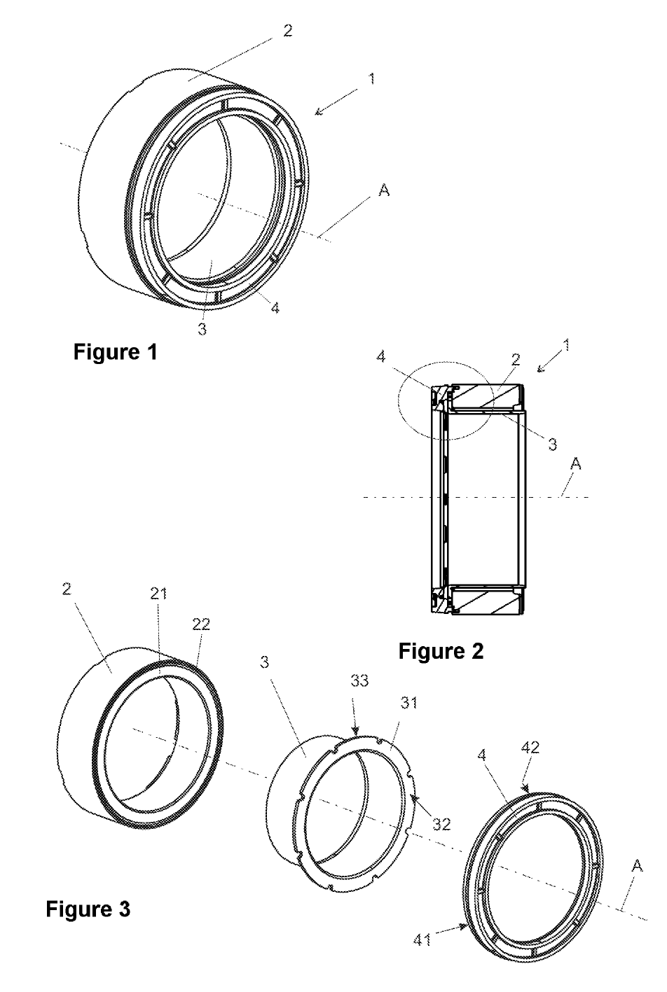

FIG. 1 represents a transducer assembly 1 according to the invention in a perspective view obliquely to the longitudinal axis A. This is formed by a magnet ring 2 and a carrier sleeve 3, which is arranged on the magnet ring 2 via a substantially ring-shaped intermediate element 4.

The intermediate element 4 has a basic ring shape and comprises a joining surface 42 on its axial end face 41 directed against the magnet ring 2. The intermediate element 4 is made of plastic, preferably as an injection molded part made of a first thermoplastic plastic.

The magnet ring 2 has the basic shape of a cylindrical pipe section with an axial end face 21 directed against the intermediate element 4, on which a joining surface 22 is formed, corresponding to the joining surface 42 of the intermediate element 4. The magnet ring 1 is designed as a plastic-bonded magnet, made from a plastic material highly filled with magnetic powder. The plastic material is also preferably a thermoplastic plastic, in the plastic matrix of which the ferromagnetic magnetic particles of the magnetic powder are embedded.

According to the invention, the plastic material from which the intermediate element 4 is formed and the plastic material which forms the plastic matrix of the magnet ring 2 are compatible with each other in terms of an integrally bonded connection, here preferably a thermal welding. It is conceivable for the first and second plastic material to be formed from an identical polymer—such as polyamide (PA), polypropylene (PP), polyphenyl sulfide (PPS) or another—or at least from similar, compatible polymer materials enabling an integrally bonded connection in the melt for the thermal weldability, or which are compatible in terms of their surface properties in regard to an integrally bonded connection by means of an adhesive placed between the joining surfaces 22 and 42.

The carrier sleeve 3 has a cylindrical tubular base body made of metal, preferably steel, which is arranged with radial play coaxially inside the magnet ring 2 and comprising an encircling annular flange 31 projecting radially outward on its end facing the intermediate element 4, forming a fastening element of the carrier sleeve 3. The one axial end face 32 of the flange 31 is directed axially against the intermediate element 4, the other axial end face 33 toward the magnet ring 2. The flange 31 may comprise form-fitting elements 34, which in the example shown are formed as radial recesses in the outer circumference.

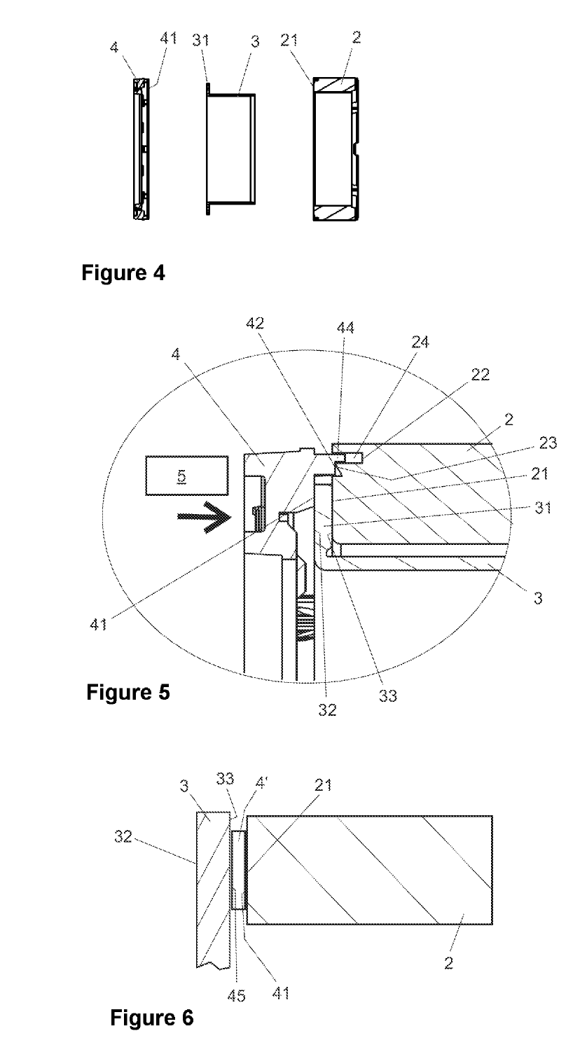

For the production of a transducer assembly 1, the magnet ring 2, the intermediate element 4 and the carrier sleeve 3 are provided and moved toward one another in the axial direction from the preliminary mounting position shown in FIGS. 3 and 4, with the flange 31 of the carrier sleeve 3 positioned axially between the magnet ring 2 and the intermediate element 4, as shown in FIG. 2.

As can be seen from the magnified representation in FIG. 5, the intermediate element 4 comprises an axial recess 43 radially inside the joining surface 42, in which the flange 31 of the carrier sleeve 3 is received, as shown. Thanks to an integrally bonded connection of the intermediate element 4 with the magnet ring 2 at the joining surfaces 22 and 42, a single composite piece is formed, with the flange 31 of the carrier sleeve 3 held by axial form-fit in the now axially covered recess 43. No integrally bonded or form-fitting connection is produced between the carrier sleeve 3 and the magnet ring 2, so that the transmission of mechanical stresses, such as those caused by different thermal expansion, from the metallic carrier sleeve 3 to the magnet ring 2 is precluded.

The integrally bonded connection between the joining surfaces 22 and 42 lying axially against one another can be produced by a thermal welding method, preferably by friction or ultrasound welding. For this, the magnet ring 2 is braced axially, while a welding punch 5, preferably a sonotrode 5 of an ultrasound welding kit, is pressed axially from the outside, i.e., from the free end face in the region of the joining surface 42, axially against the intermediate element 4, as shown by the arrow in FIG. 5. The joining surface 42 is hereby pressed against the corresponding joining surface 22 on the magnet ring 2 and vibrational energy is coupled in, by which the joining surfaces 22 and 42 are heated up and partly melted.

The joining surface 22 of the magnet ring 2 comprises an axially projecting protrusion 23, which in the embodiment depicted is fashioned as an encircling rib with knife-blade cross section. In this way, a welding material reservoir is provided, which is melted already at the start of the welding, when the protrusion 23 first makes contact with the joining surface 42. The fluid or at least viscous melted plastic is distributed in the joint gap between the joining surfaces 22 and 42, resulting in a diffusion or mixing of the plastic materials of the magnet ring 2 and the carrier sleeve 4 in the boundary surface region.

In the region of the joining surface 42 there can also be formed a form-fitting element 44 in the shape of an axially projecting, annular encircling rib. This can engage in a corresponding depression 24 in the joining surface 22. In this way, the intermediate element 4 can be positioned easily relative to the magnet ring 2.

After the end of the ultrasound excitation, the plastic solidifies in the joint region, so that an integrally bonded connection is produced and a single composite plastic part is formed from the intermediate element 4 and the magnet ring 2. In the radial recess bounded by the recess 43 and the end face 21, the flange 31 is secured by form fit in regard to the axial direction.

Alternatively, a fluid or pastelike adhesive can be introduced between the joining surfaces 22 and 42, being optimally adapted in terms of an integrally bonded connection to the plastic materials of the magnet ring 2 and the intermediate element 4.

FIG. 6 shows a detail view of a further embodiment, in which an intermediate element 4′ is fashioned as a ring and arranged between the end face 21 of the magnet ring 2 and the rear end face 33 of the flange 31. The end face 41 is integrally bonded to the end face 21 in the region of joining surfaces, not shown separately here, and possibly formed similar to the aforementioned embodiment. By its axially opposite end face 45, the intermediate element 4 is firmly joined to the end face 33 of the carrier sleeve 3.

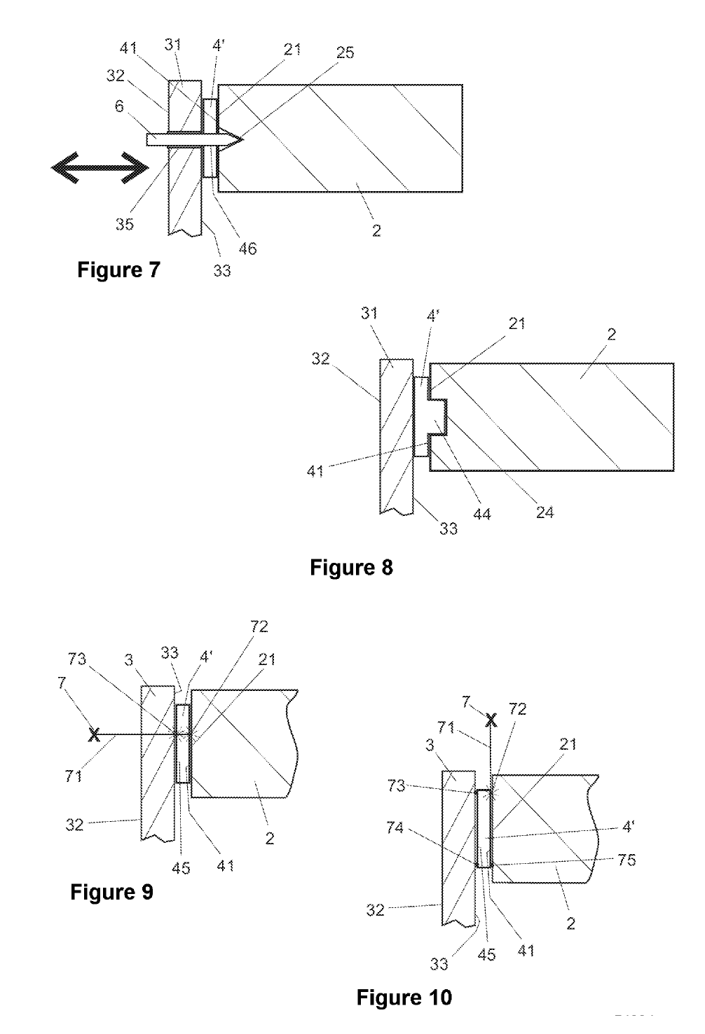

In the embodiment per FIG. 7, the flange 31 and the intermediate element 4′ comprise aligned axial apertures or openings 35 and 46, which are flush with a recess 25 in the end face 21 of the magnet ring 2. A positioning pin 6 can be inserted into the recess 25 through the apertures 35 and 46 in order to position the parts 2, 3 and 4′ exactly relative to each other during the mounting process. After the mounting, the positioning pin 6 can be pulled out once again in the axial direction, as indicated by the double arrow.

A similar embodiment to FIG. 6 is shown by FIG. 8, where the intermediate element 4 comprises in addition a form-fitting element 44 on the end face 41, corresponding in a form-fitting manner to a depression 24 in the magnet ring 2.

FIG. 9 illustrates another embodiment, which is very similar to the embodiment per FIG. 6. However, the integrally bonded connection is done by a laser welding using the laser 7. In this case, the frequency of the laser beam 71 needs to be chosen and attuned to the material of the carrier sleeve 3 so that the laser beam 71 penetrates the carrier sleeve 3. At least at the end face 21 of the magnet ring 2 there occurs a welding 72 with the end face 41 of the intermediate element 4′. However, it is also possible, by proper choice of the material of the carrier sleeve, to provide for a welding 73 between the end face 45 of the intermediate element and the end face 33 of the flange 31 of the carrier sleeve 3.

FIG. 10 illustrates a further embodiment which is very similar to the embodiment per FIG. 6. However, the form-fitting connection occurs, as already in the embodiment per FIG. 9, by a laser welding using the laser 7. It is not necessary to make sure that the frequency of the laser beam 71 is chosen such that the laser beam 71 penetrates the material of the carrier sleeve 3. At least at the end face 21 of the magnet ring 2 there occurs a welding 72 with the end face 41 of the intermediate element 4′. However, it is also possible, by proper choice of the material of the carrier sleeve, to provide for a welding 73 between the end face 45 of the intermediate element and the end face 33 of the flange 31 of the carrier sleeve 3. Further welds 74 and 75 can likewise be made, if accessible.

The features of the individually described embodiments of the invention may be combined or exchanged with each other, so far as is feasible, without leaving the realm of the invention.

### LIST OF REFERENCE NUMBERS

1 Transducer assembly
2 Magnet ring
21 End face
22 Joining surface
23 Protrusion
24 Depression
25 Recess
3 Carrier sleeve
31 Flange
32 End face
33 End face
34 Form-fitting element
35 Aperture
4, 4′ Intermediate element
41 End face
42 Joining surface
43 Recess
44 Form-fitting element
45 End face
46 Aperture
5 Welding punch (sonotrode)
6 Positioning pin
7 Laser
71 Laser beam
72, 73, 74, 75 Laser welding

1.-12. (canceled)

13. A transducer assembly for a torque and/or angle sensor, the transducer assembly comprising a pipe section-shaped magnet ring configured as a plastic-bonded magnet comprising plastic material filled with magnetic particles, the pipe section-shaped magnet ring being secured to a carrier sleeve via an intermediate element, wherein a joining surface of the intermediate element that comprises plastic is integrally bonded to a joining surface of the pipe section-shaped magnet ring that comprises the plastic material filled with the magnetic particles.

14. The transducer assembly of claim 13 wherein the plastic of the intermediate element and the plastic material of the pipe section-shaped magnet ring are thermoplastic polymers that are compatible for purposes of forming an integrally bonded connection.

15. The transducer assembly of claim 13 wherein at least one of the intermediate element or the pipe section-shaped magnet ring is an injection molded part.

16. The transducer assembly of claim 13 wherein the pipe section-shaped magnet ring is a pressed part.

17. The transducer assembly of claim 13 wherein the plastic material of the pipe section-shaped magnet ring is highly filled with magnetic materials with a degree of filling between 80% to 97% in terms of weight.

18. The transducer assembly of claim 13 wherein the intermediate element and the pipe section-shaped magnet ring are welded.

19. The transducer assembly of claim 13 wherein the intermediate element and the pipe section-shaped magnet ring are ultrasound or laser welded.

20. The transducer assembly of claim 13 wherein glue holds the intermediate element and the pipe section-shaped magnet ring together.

21. The transducer assembly of claim 13 wherein the pipe section-shaped magnet ring is connected on a substantially axial end face to an axial end face of the intermediate element.

22. The transducer assembly of claim 13 wherein the carrier sleeve is configured as a pipe section and comprises a radially outward protruding fastening element in one end region.

23. The transducer assembly of claim 22 wherein the radially outward protruding fastening element is disposed axially in a form-fitting manner between opposing end faces of the pipe section-shaped magnet ring and the intermediate element.

24. The transducer assembly of claim 22 wherein the intermediate element is disposed axially between opposing end faces of the pipe section-shaped magnet ring and the fastening element.

25. A method of producing a transducer assembly for a torque and/or angle sensor, the transducer assembly comprising a pipe section-shaped magnet ring configured as a plastic-bonded magnet comprising plastic material filled with magnetic particles, the pipe section-shaped magnet ring being secured to a carrier sleeve via an intermediate element, wherein a joining surface of the intermediate element that comprises plastic is integrally bonded to a joining surface of the pipe section-shaped magnet ring that comprises the plastic material filled with the magnetic particles, the method comprising:
providing the pipe section-shaped magnet ring configured as the plastic-bonded magnet;
integrally bonding the pipe section-shaped magnet ring to the intermediate element that comprises plastic; and
fastening the intermediate element to the carrier sleeve.

26. A transducer assembly for a torque and/or angle sensor comprising a pipe section-shaped magnet ring that is secured to a carrier sleeve via an intermediate element, wherein the intermediate element and the magnet ring are integrally bonded to one another via joining surfaces directed against one another, wherein the intermediate element is formed of a plastic at least in the region of the joining surface, wherein the magnet ring is formed as a plastic-bonded magnet from a plastic material filled with magnetic particles, which is integrally bonded to the plastic of the intermediate element.

27. The transducer assembly of claim 26 wherein the plastic of the intermediate element and the plastic material of the magnet ring are thermoplastic polymers that are compatible for purposes of forming an integrally bonded connection.

28. The transducer assembly of claim 26 wherein at least one of the intermediate element or the magnet ring is an injection molded part.

29. The transducer assembly of claim 26 wherein the magnet ring is a pressed part.

30. The transducer assembly of claim 26 wherein the plastic material of the magnet ring is highly filled with magnetic materials with a degree of filling between 80% to 97% in terms of weight.

31. The transducer assembly of claim 26 wherein the intermediate element and the magnet ring are welded.

32. The transducer assembly of claim 26 wherein the intermediate element and the magnet ring are ultrasound or laser welded.
